(19) United States
(12) Patent Application Publication
(10) Pub. No.: US 2026/0051107 A1
(43) Pub. Date: Feb. 19, 2026

(54) System and Method for Non-Intrusive Performance Isolation for Concurrent Deep Learning Networks

(71) Applicant: CentML AI Inc., Toronto (CA)

(72) Inventors: Wei ZHAO, Palo Alto, CA (US); Anand JAYARAJAN, Toronto (CA); Gennady PEKHIMENKO, Oakville (CA)

(73) Assignee: CentML AI Inc., Toronto (CA)

(21) Appl. No.: 19/270,576

(22) Filed: Jul. 16, 2025

Related U.S. Application Data
(60) Provisional application No. 63/673,440, filed on Jul. 19, 2024.

(51) Int. Cl. G06T 15/00; G06F 9/48; G06F 9/54

(52) U.S. Cl. CPC G06T 15/005; G06F 9/4881; G06F 9/545

(57) ABSTRACT

A system and method are provided for facilitating graphics processing unit (GPU) sharing. The method includes providing a transparent virtualization layer positioned between one or more applications and one or more GPUs to be used by the one or more applications; intercepting device application programming interface (API) calls at the virtualization layer; and executing a task-agnostic scheduling algorithm to prioritize execution of tasks associated with the API calls, by the one or more GPUs, by prioritizing high-priority tasks while opportunistically scheduling kernels on the one or more GPUs from best effort tasks during GPU idle cycles.

### CROSS-REFERENCE TO RELATED APPLICATION(S)

This application claims priority to U.S. Provisional Patent Application No. 63/673,440 filed on Jul. 19, 2024, the entire contents of which are incorporated herein by reference.

### TECHNICAL FIELD

The following generally relates to concurrent deep learning networks and, in particular, to non-intrusive performance isolation for such networks.

### BACKGROUND

Deep learning (DL) has demonstrated astonishing performance across a wide range of applications, including image recognition [25, 28, 50], machine translation [7, 19, 30, 49], recommendation systems [3, 64], and autonomous driving [14, 61]. Recent advances in generative AI [10, 46], exemplified by the development of large language models (LLMs) like ChatGPT [39], have further elevated the influence of DL to unprecedented levels. To facilitate the research and deployment of DL-based applications, many organizations [29, 47, 56] are investing in building computing infrastructures with large fleets of GPU devices. For example, Meta is building two data center-scale clusters for AI, each equipped with hundreds of thousands of NVIDIA H100 GPUs with an estimated cost as high as half a billion dollars [21, 29]. As the demand for computational resources continues to escalate, efficient utilization of GPUs becomes paramount to mitigate costs and ensure scalability for AI applications.

Nevertheless, studies have noted significant GPU underutilization in large-scale DL clusters. For example, a recent study by Alibaba revealed that the median GPU utilization in their production DL cluster can go as low as 4.2%. This inefficiency results from the need for production clusters to accommodate a diverse range of workloads, many of which are unable to fully leverage the capacity of the GPUs. For instance, training processes can potentially underutilize GPUs due to bottlenecks in CPU execution such as stalls caused by data fetching and preprocessing [6]. The utilization of online inference tasks, on the other hand, is intrinsically tied to real-time request rates, which are subject to substantial fluctuations causing unpredictable GPU idleness [33]. For instance, Microsoft's production trace [65] has revealed significant burstiness in user requests, with frequent spikes in demand of up to 50× the average. This also makes usage prediction and resource allocation challenging for inference workloads, resulting in resource over-provisioning to ensure high quality of service [33, 62], which exacerbates the underutilization problem.

To enhance the efficiency of DL clusters, recent studies [27, 36, 59, 60] suggest GPU sharing as a promising solution. This approach aims to enhance hardware utilization by allowing multiple low-GPU tasks to share a single GPU's resources. The same Alibaba study conducted a simulation on their production traces and demonstrated that an effective GPU sharing mechanism could potentially reduce the amount of GPU resources required by the cluster by 50% on average and up to 73% during peak hours. These findings underscore the potential of GPU sharing in mitigating the GPU underutilization problem and significantly improving the overall efficiency of large-scale DL clusters.

Despite these promising results, GPU sharing has not yet achieved widespread adoption in production. One major obstacle is the lack of performance isolation mechanisms in most current GPU sharing systems. Many workloads within DL clusters are governed by service-level agreements (SLAs), which impose stringent performance requirements, usually on the order of milliseconds [15]. These workloads are commonly referred to as high-priority or latency-critical tasks. By contrast, workloads that can tolerate extended processing times are known as low-priority or best-effort tasks. While it seems logical to pack best-efforts tasks along with high-priority tasks to utilize the GPU idle time caused by the latter, this approach can cause significant interference to the performance of the high-priority workloads, potentially violating their SLAs. Experiments on state-of-the-art GPU sharing mechanisms reveal that such performance interference can cause up to a 20× slowdown in tail latency (see Section 5 below), making them impractical for use in practice.

Another hindrance to the broader adoption of GPU sharing lies in the intrusive nature of many current sharing solutions [4, 12, 13, 59, 60, 67]. Using such solutions require extensive modifications to user-level code or the underlying DL frameworks (e.g., PyTorch [41], TensorFlow [2]). These solutions not only greatly limit the flexibility of users in developing their workloads but also impose a substantial burden on the users and the cluster providers for workload adaptation and framework upgrades, leading to significant integration and maintenance costs [27]. Moreover, many of these solutions require the workloads to adhere to specific characteristics, such as ensuring GPU kernels used by the workload are always idempotent [24]. These constraints often only apply narrowly in production clusters that host a diverse range of workloads with varying characteristics.

In light of these observations, it has been found that for practical deployment in production DL clusters, a GPU sharing system should meet the following three criteria. (1) Non-intrusive to seamlessly integrate into existing clusters and DL workloads, (2) provide performance isolation guarantees to ensure that the service-level requirements of high-priority tasks are maintained effectively during shared execution, and (3) be generalizable across a diverse range of DL applications.

### SUMMARY

As identified above, GPU underutilization is a significant concern in many production deep learning clusters, leading to prolonged job queues and increased operational expenses. A promising solution to this inefficiency is GPU sharing, which improves resource utilization by allowing multiple workloads to execute concurrently on a single GPU. However, the practical deployment of GPU sharing in production settings faces critical obstacles due to the limitations of existing mechanisms, such as high integration costs, inadequate performance isolation, and limited application compatibility. To address these issues, the system described herein provides a non-intrusive GPU sharing mechanism that provides robust performance isolation and comprehensive workload compatibility. The system operates as a virtualization layer between applications and GPUs, transparently orchestrating the device execution of concurrent workloads. Important to the system's robust performance isolation capability lies in its fine-grained thread-block level GPU kernel scheduling strategy, which allows the system to effectively mitigate interference caused by workload co-execution.

An evaluation, conducted on a diverse set of workload combinations, demonstrates that the system is capable, on average, of incurring only 7.2% overhead on the 99th-percentile latency of high-priority inference tasks when executed concurrently with best-effort training workloads compared to 188.9% overhead exhibited by the state-of-the-art GPU sharing systems like TGS, while achieving over 80% of TGS's system throughput.

In one aspect, there is provided a method of facilitating graphics processing unit (GPU) sharing, comprising: providing a transparent virtualization layer positioned between one or more applications and one or more GPUs to be used by the one or more applications; intercepting device application programming interface (API) calls at the virtualization layer; and executing a task-agnostic scheduling algorithm to prioritize execution of tasks associated with the API calls, by the one or more GPUs, by prioritizing high-priority tasks while opportunistically scheduling kernels on the one or more GPUs from best effort tasks during GPU idle cycles.

In certain example embodiments, the method includes applying at least one task-agnostic kernel transformations.

In certain example embodiments, an application-side client library intercepts device code and the API calls initiated by client processes and forwards the device code and API calls to a server providing the transparent virtualization layer.

In certain example embodiments, wherein the server is responsible for managing device execution and scheduling.

In certain example embodiments, wherein the virtualization layer provides performance isolation for the high-priority tasks by scheduling kernels from the best effort tasks at a block-level granularity using at least one of a slicing scheduling primitive and a preemption scheduling primitive.

In certain example embodiments, the slicing scheduling primitive divides a large kernel into a plurality of smaller segments, enabling more controlled scheduling.

In certain example embodiments, the preemption scheduling primitive allows for an interruption of active kernels.

In certain example embodiments, the slicing and preemption scheduling primitives are applied on GPU kernels through a series of transformation passes on kernel device code obtained through an interception of device API calls.

In certain example embodiments, the scheduling algorithm comprises a priority-aware scheduler that employs a profile-guided resource provisioning policy.

In certain example embodiments, the provisioning policy leverage runtime measurements to determine an optimal launch configuration for each best effort kernel through a search process.

In certain example embodiments, the scheduling algorithm aims to facilitate priority-enforced concurrent execution of one high priority task alongside multiple best effort tasks.

In certain example embodiments, the scheduling algorithm performs at least one of: a kernel transformer, which leverages intercepted device code to convert kernels into slicing and preemptive-style kernels; a transparent profiler, which profiles the performance of the transformed kernels under various launch configurations at runtime and predicts their estimated turnaround latencies; and a priority-aware scheduler, which integrates the kernel transformer and transparent profiler and strategically schedules GPU execution of concurrent processes in a priority-aware manner.

In another aspect, there is provided a computer readable medium comprising computer-executable instructions that, when executed by at least one process of a computing system, cause the computing system to facilitate graphics processing unit (GPU) sharing by performing the method described above.

In another aspect, there is provided a computing system comprising at least one processor and memory, the memory comprising computer executable instructions that, when executed by the at least one processor, cause the computing system to facilitate graphics processing unit (GPU) sharing by performing the method described above.

### BRIEF DESCRIPTION OF THE DRAWINGS

Embodiments will now be described with reference to the appended drawings wherein:

FIG. 1 is an example of a computing environment in which a GPU virtualization layer is provided between applications and one or more GPUs.

FIG. 2 is a block diagram of an example of a configuration for a computing device.

FIG. 3 is an example of a system architecture for providing the GPU virtualization layer.

FIG. 4a illustrates slicing and preemption kernel transformations.

FIG. 4b illustrates a unified synchronization kernel transformation.

FIG. 5 illustrates a priority-aware scheduling algorithm.

FIG. 6 illustrates an analysis of 99th-percentile latency and system throughput across different high-priority inference and best-effort training workload combinations under various GPU sharing mechanisms.

FIG. 7a illustrates a time-series visualization of user traffic, tail latency, and throughput over time for BERT inference co-located with BERT training across different GPU sharing systems.

FIG. 7b illustrates latency and throughput for high-priority BERT and Llama2-7B inference co-located with BERT, GPT-2, and Whisper training under the present system and TGS across different traffic loads.

FIG. 8a illustrates scalability performance of the present system with respect to number of concurrent workloads.

FIG. 8b illustrates performance decomposition of the present system for BERT inference.

FIGS. 8c-i and 8c-ii illustrate latency and throughput under different turnaround latency threshold settings.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

Building on the above objectives, a system is described herein that provides, a nonintrusive GPU sharing system for large-scale production DL clusters that ensures performance isolation of latency-critical high-priority tasks when co-located with best effort tasks, while maximizing hardware efficiency and overall system throughput. The system has been designed as a transparent virtualization layer between the application-level and the GPU. It intercepts GPU kernel launch API calls and employs a task-agnostic scheduling algorithm to prioritize high-priority kernels, while opportunistically scheduling best-effort kernels during GPU idle periods.

To efficiently co-locate high-priority and best-effort tasks on a GPU with performance isolation guarantees, it is considered important to schedule best-effort kernels in a controlled manner when the GPU is idle and promptly switch to high-priority kernels as required. However, modern GPUs lack kernel scheduling primitives to terminate a running kernel and only allow context switching between kernels at the granularity of entire kernels [22, 24]. It has been observed that this limitation introduces significant overhead on high-priority tasks, especially since many best-effort DL workloads involve long-running kernels. To overcome this challenge and enable finer-grained kernel scheduling, the system is configured to use two software-level kernel scheduling primitives: slicing and preemption. Slicing divides large kernels into smaller segments, while preemption allows for the interruption of active kernels. An important insight is that these two scheduling primitives can be implemented non-intrusively and in a task-agnostic manner through a series of GPU kernel transformation passes, leveraging the GPU programming model which organizes kernels as a collection of independent thread blocks.

While slicing and preemption are effective mechanisms to manage co-execution interference, each has its trade-offs. Kernel slicing is a lightweight transformation but can incur higher overhead due to multiple kernel launches. In contrast, kernel preemption requires only a single kernel launch but involves a more complex transformation with potential synchronization overhead. Due to these differences, the optimal choice of scheduling primitives and configuration parameters (e.g., the degree of slicing) varies across different kernels. To this end, the present system may use a profile-guided resource provisioning strategy in its scheduling algorithm that transparently profiles the performance of best-effort kernels on-the-fly across various scheduling configurations to select the best option to meet the latency requirements of the high-priority task. This approach ensures that interference from best-effort tasks remains within acceptable limits while striving for optimal overall system throughput.

To evaluate the system's ability to provide effective performance isolation, a comprehensive benchmark suite has been prepared which includes six training and six inference workloads that cover a wide range of popular DL models and frameworks (details shown in Table 2). The co-located performance of latency-critical inference tasks and best-effort training tasks are evaluated by simulating the production traffic patterns for the inference tasks using the publicly available Microsoft Azure Function Trace 2021 (MAF2) dataset [65]. Across all the combinations, the system has been found to be capable of incurring a mere 7.2% overhead on average in the 99th-percentile latency of inference tasks, compared to 252.3%, 345.0%, 195.5%, and 188.9% exhibited by state-of-the-art non-intrusive GPU sharing solutions, Time-Slicing, MPS, MPS-Priority, and TGS respectively.

At the same time, the system has been found to be able to achieve 80% of the system throughput attained by TGS, demonstrating the effectiveness of Tally in maximizing the GPU efficiency while providing strong performance isolation guarantees.

In summary, the following disclosure provides:
i) a non-intrusive GPU sharing solution with robust performance isolation guarantees,
ii) a unique approach to achieve fine-grained GPU kernel scheduling in a non-intrusive and task-agnostic manner using kernel slicing and preemption primitives. It is further proposed to provide a priority-aware kernel scheduler that dynamically selects the appropriate scheduling primitives to optimize GPU throughput while preserving performance isolation guarantees.
iii) an evaluation of the system on a diverse range of inference and training workloads to show that the system can achieve system throughput on-par with state-of-the-art GPU sharing solutions while providing strong performance isolation.

### 1. Computing Environment

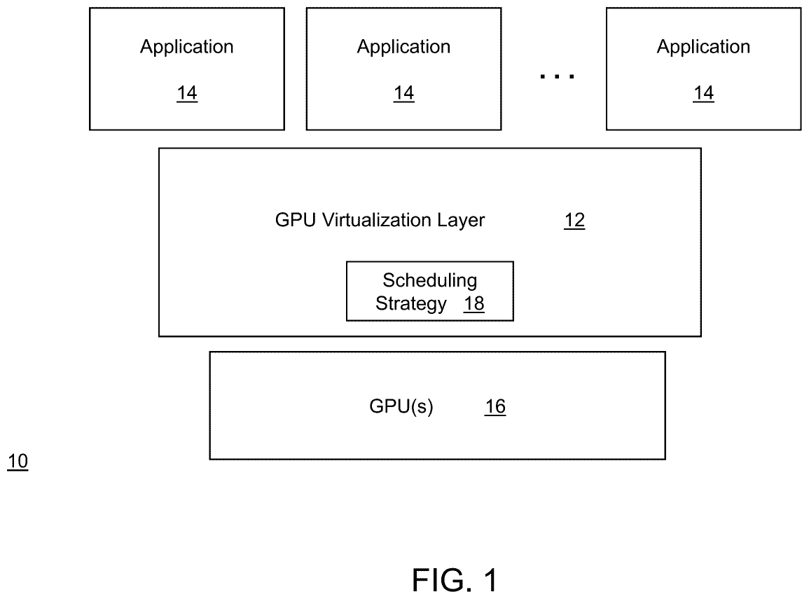

Referring now to FIG. 1, an example of a computing environment 10 is shown in which the present methods, processes and optimizations may be deployed. The computing environment 10 includes a GPU virtualization layer 12, which is interposed between one or more applications 14 and one or more GPUs 16. The GPU virtualization layer 12 includes a scheduling strategy 18 that may be executed to optimize utilization of the GPU(s) 16.

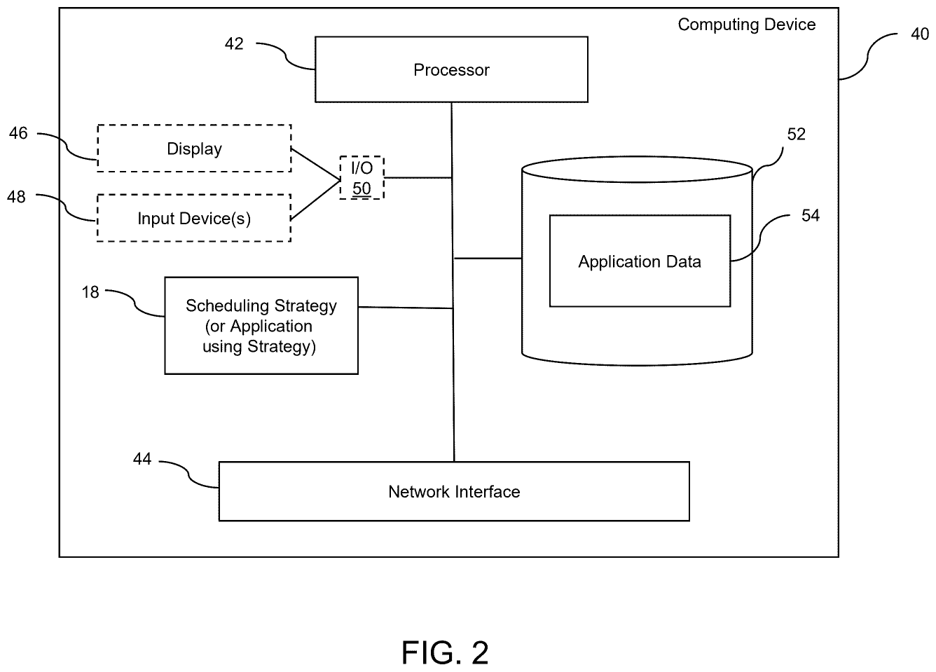

It can be appreciated that the GPU virtualization layer 12 may be running on one or more computing devices 40 (e.g., see FIG. 2). Such computing devices 40 (or computing systems) may include, but are not limited to, a personal (e.g., desktop) computer, a server computer or other computing system that is equally or more powerful or otherwise suitably adapted to compiling computer code, e.g., for use with machine learning and/or other applications, such as LLMs.

The GPU virtualization layer 12 may be hosted or otherwise run on the one or more computing devices 40 or may be accessed by the computing device(s) 40 over a communication network (not shown). Such communication network(s) may include the Internet, accessed via, for example, a telephone network, cellular, and/or data communication network to connect different types of client-and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). The GPU virtualization layer 12 may be embodied in an application, which may take the form of a mobile-type application (also referred to as an “app”), a desktop-type application, an embedded application in customized computing systems, or an instance or page contained and provided within a web/Internet browser, to name a few.

The application(s) 14 may be provided by a separate one or more computing devices 40 or computing system, by a separate entity or may be integrated with a system or application running the GPU virtualization layer 12 within the same computing device(s) 40 or computing system. As such, the configuration shown in FIG. 1 is illustrative and other computing device/system configurations are possible. For example, the computing environment 10 shown in FIG. 1 may represent a single device or the integration/cooperation of multiple electronic devices such as a client device and server device or a client device and a remote or offsite storage or processing entity or service or multiple client or server devices working together in scheduling tasks for the GPU(s) 16. That is, the computing environment 10 may be implemented using any one or more electronic devices including standalone devices and those connected to offsite storage and processing operations (e.g., via cloud-based computing storage and processing facilities).

FIG. 2 shows an example of one such computing device 40, e.g., from a set of one or more computing devices 40, which may be utilized by any one or more of the entities shown in FIG. 1, for example, a personal electronic device or server used to provide the scheduling strategy 18 or other computing device 40 used to communicate with a device providing the application(s) 14. The computing device 40 in FIG. 2 may, additionally or alternatively, provide an example of a device on which a GPU 16 may be deployed or accessed. Similarly, the computing device 40 in FIG. 2 may provide an example of a device on which downstream application(s)—not shown, may be deployed.

In this example, the computing device 40 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device(s) 40 may also include the scheduling strategy 18 (or other application(s)), a data store 52, and client application data 54. The data store 52 may represent a database or library or other computer-readable medium configured to store data and permit retrieval of data by the computing device 40. The data store 52 may be read-only or may permit modifications to the data. The data store 52 may also store both read-only and write accessible data in the same memory allocation. In this example, the data store 52 stores the application data 54 for the scheduling strategy 18 that is configured to be executed by the computing device 40 for a particular role or purpose.

While not delineated in FIG. 2, the computing device(s) 40 include(s) at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 2 illustrates examples of modules and applications stored in memory on the computing device 40 and executed by the processor(s) 42.

It can be appreciated that any of the modules and applications shown in FIG. 2 may be hosted externally and may be available to the computing device 40, e.g., via a network interface 44. The data store 52 in this example stores, among other things, the application data 54 that can be accessed and utilized by an application on that device such as the scheduling strategy 18. The data store 52 may additionally store one or more software functions or routines in a cache or in other types of memory.

As shown in FIG. 2, the computing device(s) 40 may, optionally (e.g., when configured as a personal electronic device such as a smartphone or tablet), include a display 46 and one or more input device(s) 48 that may be utilized via an input/output (I/O) module 50. That is, such components may be omitted when the computing device 40 does not interact with a user.

While examples referred to herein may refer to a single display 46 for ease of illustration, the principles discussed herein may also be applied to multiple displays 46, e.g., to view portions of UIs rendered by or with an application on separate side-by-side screens. That is, any reference to a display 46 may include any one or more displays 46 or screens providing similar visual functions. The application receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 40. While shown generally in FIG. 2, it can be appreciated that the computing environment 10 may, as described below, utilize a single computing machine with multiple GPUs.

For example, modern large-scale DL clusters are designed to support a diverse range of workloads, encompassing both training and inference tasks for a variety of model types, such as convolutional neural networks (CNNs), transformer-based large language models (LLMs), graph neural networks (GNNs), and reinforcement learning (RL) models. These tasks are implemented using various DL frameworks such as PyTorch, TensorFlow, and JAX, alongside proprietary software. The training process is inherently iterative, requiring substantial computational resources over extended periods, making training workloads primarily throughput-oriented. In contrast, inference is often deployed as online services, such as personalized recommendations or autonomous driving systems, which demand low-latency responses to deliver timely results.

The execution of DL models involves a diverse set of operators, among which matrix multiplication stands out as one of the most critical. Operators like matrix multiplication are characterized by their high computational intensity, coupled with extensive parallelism. Given these intrinsic properties of DL model execution, GPUs have emerged as the dominant accelerator type employed in DL clusters. The massively parallel architecture of GPUs makes them particularly well-suited for the computational demands of DL workloads.

### 2. Background

### GPU Architecture and Programming Model

While there are variations among vendors (e.g, NVIDIA and AMD), modern GPUs used in DL clusters fundamentally follow similar architecture and programming model. GPUs are equipped with thousands of parallel processing units called Streaming Multiprocessors (SMs). Kernels, the computational units executed on GPUs, are programmed using specialized languages like CUDA [38]. GPU kernels follow a hierarchical thread structure consisting of threads, warps, thread blocks, and grids. Threads within a kernel identify themselves using built-in variables such as threadIdx and blockIdx to determine their task assignments. Warps are groups of threads that execute in SIMT fashion. All the warps within a thread block are scheduled to a single SM and can cooperate using fast on-chip shared memory. Additionally, threads within a block can synchronize their execution to coordinate memory accesses using synchronization primitives. Finally, thread blocks within a grid can be scheduled and executed independently in any order, either sequentially or in parallel [38]. This independent scheduling capability allows thread blocks to scale effectively across multiple SMs.

### GPU Sharing Systems

The diverse nature of DL workloads, coupled with their inherent inefficiencies, has raised significant concerns about GPU underutilization in many production DL clusters [26, 59]. To mitigate this problem, researchers have proposed numerous cluster-level optimizations [54, 58-60], among which GPU sharing is a promising approach to improve utilization by consolidating multiple low-utilization jobs onto the same GPU. From an implementation perspective, current GPU sharing solutions can be broadly categorized into two levels: application and runtime. Application-level solutions propose a new programming interface for writing efficient DL workloads that can be executed concurrently. For example, Salus [60] exposes a set of scheduling primitives for defining the iteration boundaries of a training job, enabling the scheduler to manage different training workloads at the iteration-level granularity. Similarly, HFTA [54] provides APIs that allow developers to write multiple hyper-parameter tuning jobs as a single application, which can then be efficiently executed on a single GPU. Unlike application-level solutions that necessitate modifications to user-level applications, runtime-level GPU sharing solutions operate transparently by integrating directly into either DL frameworks [59] (e.g., PyTorch or Tensor Flow [2]), container orchestration systems [57] (e.g., Kubernetes [23]), or the GPU driver [24]. These systems typically perform resource sharing at a more fine-grained level. For instance, TGS [57] is designed to be deployed on GPU containers in Kubernetes and schedules workloads at the GPU kernel level, while REEF [24] extends GPU drivers to offer more fine-grained thread-level scheduling capabilities. The transparent nature of many these solutions allows for adoption across a wider range of applications with minimal effort. However, designing these solutions is often challenging due to the lack of application-level context.

### 3. GPU Sharing in the Wild

Despite the wide range of solutions, current GPU sharing systems are inadequate for practical deployment in DL clusters due to one or more of the following key limitations.

### High Integration and Maintenance Cost

Many existing GPU sharing systems are fundamentally intrusive in nature, necessitating extensive modifications to user code to be used in practice. This is particularly evident in application-level systems, where users must adapt their workloads to the specific programming interfaces proposed by these solutions. Such intrusive approaches not only burden the users, but also may limit their flexibility in application development [27]. Similarly, runtime-level GPU sharing solutions that are designed as extensions of DL frameworks impose a significant burden on cluster managers to implement and maintain them across diverse frameworks used by the users. Consequently, deploying these solutions in practice often involves substantial integration and maintenance costs, especially given the rapidly evolving landscape of the modern DL ecosystem. On the other hand, runtime-level GPU sharing solutions that seamlessly integrate with the container orchestration system or GPU driver, although may seem non-intrusive, they often impose implicit requirements on user code to gather additional application context needed for making effective scheduling decisions. This includes requirements such as enabling the ability to temporarily launch applications in a specialized profiling environment before execution [48], or mandating applications to implement checkpoint and restore mechanisms [37, 58]. Enforcing such programming practices in large-scale multi-tenant clusters is often impractical [56].

### Lack of Performance Isolation Guarantees

In production DL clusters, many inference tasks are governed by service-level agreements (SLAs) which impose strict latency requirements on their response times, typically of the order of a few milliseconds to seconds [15]. However, current GPU sharing solutions often lack support for performance isolation, resulting in unacceptable performance degradation for latency critical inference tasks when co-located with other tasks [22]. For instance, NVIDIA's native runtime-level GPU sharing solution, MPS [1], is designed to eagerly schedule as many GPU kernels from co-located tasks as possible. Although this design maximizes the GPU utilization, it can cause significant queuing delays for executing kernels of high-priority inference tasks. In such scenarios, our experiments (see Section 5) indicate that, the tail latency of a co-located inference task can go as high as 20× its standalone performance.

Effectively sharing GPU resources while ensuring performance isolation for latency-critical tasks requires the ability to prioritize one task over the other and rapidly switch between them based on their resource demands. The speed of context-switching between tasks, which is denoted herein as turnaround latency, is dictated by the scheduling granularity used in GPU sharing systems. As described in Section 2, the scheduling granularity used by prior works primarily fall into four categories, from coarsest to finest: iteration-level (e.g. Salus [60]), kernel-level (e.g., TGS [57]), block-level (e.g. EffiSha [13]), and thread-level (e.g. REEF [24]). To illustrate the effect of scheduling granularity on the tail latency, the following presents a representative empirical study in Table 1 below, where a latency-critical BERT inference task is co-executed with a Whisper [43] model training workload on an NVIDIA A100 GPU.

TABLE 1
Comparison of BERT inference latency against turnaround
latency of different scheduling granularity for
Whisper training on NVIDIA A100 GPU

| | |
|---|---|
| Inference time | Turnaround latency (Whisper) |

| (BERT) | Iteration | Kernel | Block | Thread |
|---|---|---|---|---|
| 3.93 ms | ~3 s | ~10 ms | ~304 μs | ~38 μs |

In this experiment, one has empirically estimated the turnaround latency for different scheduling granularities on the Whisper model and compare it to the response time of BERT inference. Since BERT inference takes only 3.93 ms, providing strong performance isolation of such tasks require sub-millisecond-level turnaround latency. However, both iteration-level and kernel-level scheduling have been found to only achieve turnaround latencies of 3 s and 10 ms, respectively. As a result, scheduling the Whisper training task at these granularities can introduce 2.5-760× higher overhead on BERT's latency. In contrast, block-level and thread-level scheduling achieve microsecond-scale turnaround latencies of 304 μs and 38 μs respectively resulting in only mere 1-7% overhead.

From these results, it may be concluded that to achieve practical performance isolation guarantees, GPU sharing solutions should schedule resources at either the block-level or thread-level granularity. Unfortunately, existing solutions either do not meet these criteria (e.g., AntMan, TGS) or prove ineffective in diverse production DL clusters due to their intrusive nature (e.g., EffiSha, Orion) or lack of generalizability (e.g. REEF). This brings one to the third limitation.

### Reliance on Narrowly Applicable Workload Characteristics

Many state-of-the-art GPU sharing systems rely on specific workload characteristics in their scheduling strategies. For instance, AntMan and TGS can provide runtime-level GPU sharing support but are limited to training workloads with predictable GPU kernel execution patterns. REEF, on the other hand, offers strong performance isolation for inference workloads, however, needs the GPU kernels to be idempotent to support thread-level kernel scheduling strategy, i.e., the kernel should always produce the same output for the same input, regardless of how many times it is executed. While these systems demonstrate benefits for certain class of applications, their underlying assumptions are often not applicable to large-scale multi-tenant DL clusters that support a diverse range of workloads with varying characteristics. Prior studies [56] have revealed that DL clusters are often agnostic to the specific semantics of running workloads and extracting application-level context is largely infeasible. As a result, GPU sharing solutions that depend on specific task characteristics are not viable in many DL clusters.

In summary, the following proposes a GPU sharing solution for large-scale DL clusters that addresses all three of the aforementioned limitations.

### 4. Proposed System Design

To facilitate the practical deployment of GPU sharing in production clusters, a system is disclosed here, which may be interchangeably referred to as “Tally”, a non-intrusive GPU sharing system that offers robust performance isolation for latency-critical tasks during shared execution with throughput-oriented best-effort tasks on a diverse range of DL workloads. Tally is designed as a virtualization layer operating transparently between applications and GPUs, intercepting device API calls and employs a task-agnostic scheduling algorithm to prioritize execution from high-priority tasks while opportunistically scheduling kernels from best-effort tasks during GPU idle cycles.

Tally ensures performance isolation for high-priority tasks by scheduling kernels from best-effort tasks at the block-level granularity using two scheduling primitives: slicing and preemption. Slicing divides a large kernel into numerous smaller segments, enabling more controlled scheduling, whereas preemption allows for the interruption of active kernels. Importantly, two key observations have been made that allow applying these two scheduling primitives in a task-agnostic and non-intrusive manner.

First, unlike thread-level scheduling, thread blocks within a GPU are guaranteed to operate independently, making block-level scheduling universally applicable across GPU kernels. Moreover, while thread-level scheduling can provide stronger performance isolation, it has been found that block-level scheduling is sufficient for most practical scenarios.

Second, the slicing and preemption scheduling primitives can be applied on GPU kernels through a series of transformation passes on the kernel device code (PTX in case of NVIDIA GPUs) obtained through the interception of device API calls. Leveraging these insights, we integrate the slicing and preemption primitives to Tally's scheduling algorithm enabling microsecond-scale turnaround latency, allowing Tally to promptly switch execution between high priority and best-effort tasks and maintain the millisecond scale latency requirements in many latency-critical tasks.

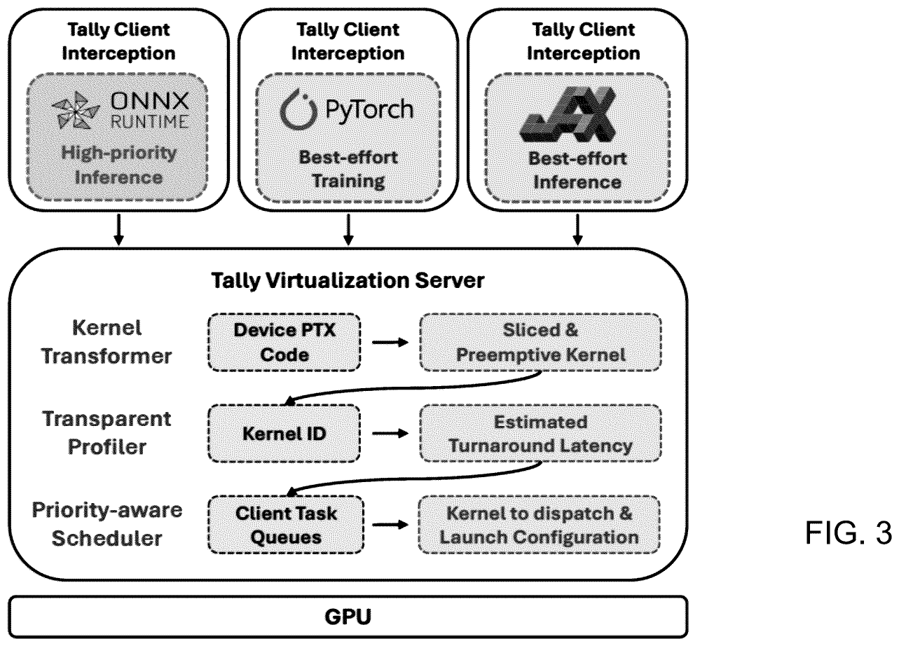

FIG. 3 shows the high-level design of Tally, following a client-server architecture. On the application side, Tally's client library intercepts device code and API calls initiated by client processes and forwards them to the Tally server, which is responsible for managing the actual device execution and scheduling. The objective of the Tally server is to facilitate priority-enforced concurrent execution of one high priority task alongside multiple best-effort tasks. To achieve this, Tally server incorporates three key components: a (1) kernel transformer, which leverages intercepted device code to convert kernels into slicing and preemptive-style kernels, a (2) transparent profiler, which profiles the performance of the transformed kernels under various launch configurations at runtime and predicts their estimated turnaround latencies, and finally a (3) priority-aware scheduler, which integrates capabilities of the aforementioned modules and strategically schedules GPU execution of concurrent processes in a priority-aware manner. In the following sections, we provide details regarding each of these components.

### 4.1 Kernel Transformations

It is first illustrated how Tally supports the slicing and preemption primitives through a series of transformation passes on the kernel device code.

### Slicing Transformation

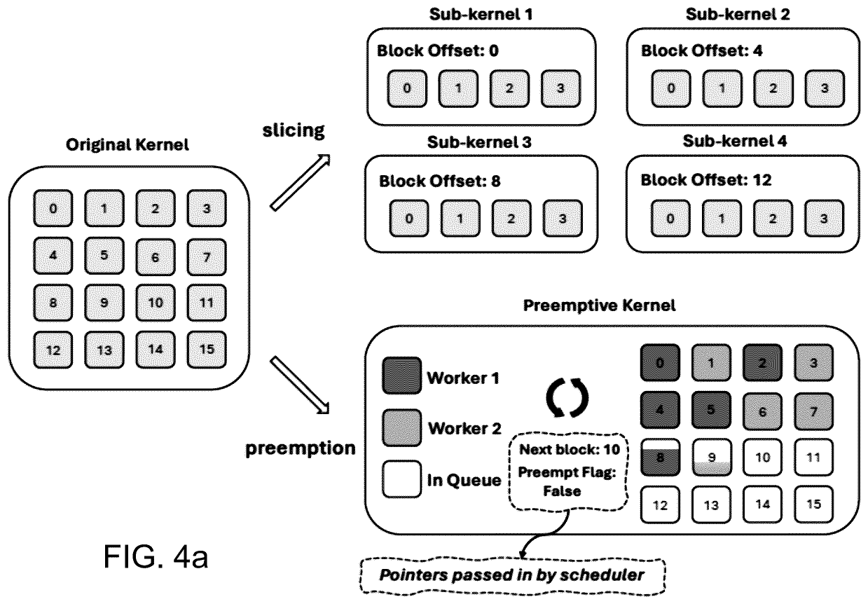

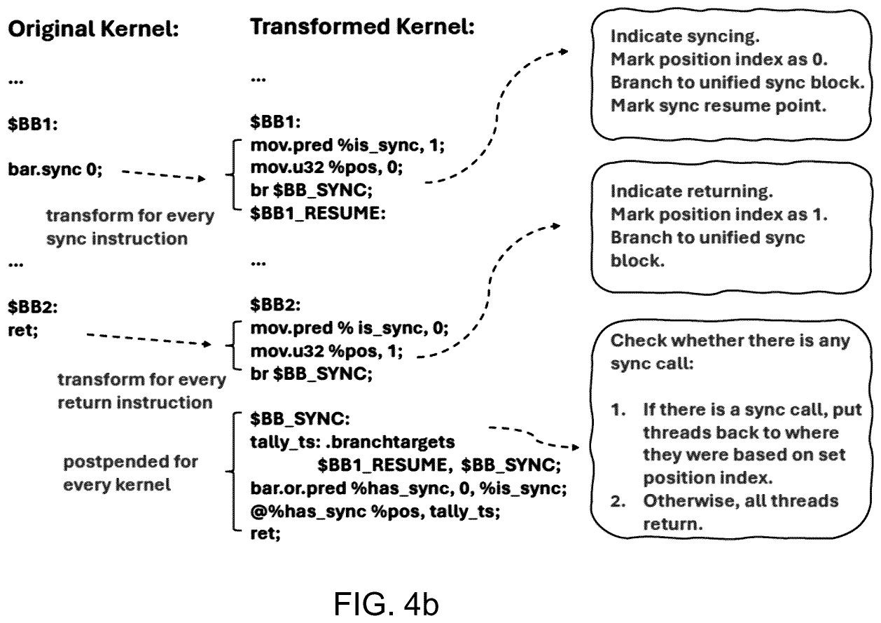

Slicing is a technique that facilitates fine-grained control over kernel execution by partitioning the thread blocks of a kernel into multiple sub-kernels. FIG. 4(a) illustrates this concept, where a kernel originally composed of 16 thread blocks is divided into 4 sub-kernels, each containing 4 blocks. As thread blocks within a kernel are guaranteed independent, theoretically, this partitioning should preserve the original kernel's functional semantics. However, naively launching the original kernel 4 times with 4 thread blocks each yields incorrect results, as GPU threads rely on built-in variables such as blockIdx to determine their task assignment. Specifically, the blockIdx variable informs a thread of the index of the block it resides in within the kernel execution, allowing it to properly compute its assigned task index. In the original kernel, threads are exposed to blockIdx values ranging from 0 to 15 (as 16 blocks in total are launched). Yet, when each sub-kernel is launched, the threads are exposed to blockIdx values ranging from 0 to 3, causing all sub-kernels to execute the first 4 blocks of the kernel, which will lead to erroneous results. To address this issue, a kernel's PTX code can be modified to take in an additional offset variable in its parameters and substitute occurrences of blockIdx with the sum of the offset and the original blockIdx. This approach enables threads within a sub-kernel to identify their corresponding subset of blocks. For instance, sub-kernel 2 can reconstruct its corresponding block indices from 4 to 7 by adding a block offset of 4 to the new block-Idx. With this mechanism, the collective work done by the sub-kernels can properly resemble the original kernel execution, while offering the scheduler flexible scheduling at the block-level granularity.

### Preemption Transformation

Tally introduces a transformation that makes kernels preemptible while preserving their functional semantics. The preemption transformation in Tally is inspired by the Persistent Thread Block (PTB) programming paradigm, which deviates from the traditional programming model where the number of thread blocks launched by a kernel is proportional to the amount of work it performs. Instead, the PTB model employs a flexible number of worker blocks to perform all the work. As an example, in FIG. 4(a), rather than launching 16 thread blocks of the original kernel, the PTB model launches 2 worker blocks to process the 16 blocks in an iterative and dynamic manner. These workers continuously fetch and increment a global integer representing the next task index. Similar to how subkernels in slicing utilize block offsets to recompute their block indices from the original kernel execution, workers in PTB use the task index to reconstruct the corresponding block indices for the current iteration. For example, in the illustrated case where thread blocks are structured in a 1-dimensional grid, a fetched task index of 8 indicates that the worker should perform the execution of the thread block with blockIdx 8. In the case of higher-dimensional grids, block indices can be computed from the integer task index by referring to the original kernel's grid dimension.

An important observation from the PTB model is that the progress of the kernel execution is effectively encapsulated in the global task index. Since the execution is now transformed into an iterative approach, kernels can potentially terminate early and later be resumed from the point at which they ended, using the task index. This can be achieved by introducing an additional Boolean variable to the PTB kernels as a flag for signaling preemption. At the start of each iteration, workers check this flag to detect preemption signals, allowing block-level preemption within kernels. Tally can automatically convert kernels into this preemptive style by wrapping the original kernel function in the device code with an outer loop using control flow logic. For instance, all return statements are transformed into branch instructions that direct the execution flow to the start of the iteration, ensuring that each worker block continues execution until all tasks are processed or a preemption signal is received.

Furthermore, a synchronization call is introduced at the end of each iteration to ensure that threads within a worker block process a single block at a time, preventing potential race conditions and maintaining correctness of computation.

However, since the preemption transformation replaces return statements with branching statements that synchronizes threads at the start of the iteration, it can potentially lead to threads within the same block synchronizing at different places. Such divergence in synchronization is an undefined behavior in the GPU programming model and, in practice, results in infinite kernel stalls, making such transformations unsafe. To address this issue, Tally introduces a prepositional kernel transformation pass, which may be denoted as the unified synchronization transformation.

The algorithm of the transformation is depicted in FIG. 4(b). As illustrated, this transformation modifies all synchronization and return instructions by redirecting them to a newly introduced unified synchronization point that verifies if all threads are in a return state. Threads from synchronization points loop back to their previous positions, while those returning are held until all threads align. This unified synchronization transformation eliminates divergences in thread block synchronization, and in turn, the infinite stall issue. Through this prepositional transformation stage, the preemptive transformation can be applied automatically and safely.

### 4.2 Priority-Aware Scheduling

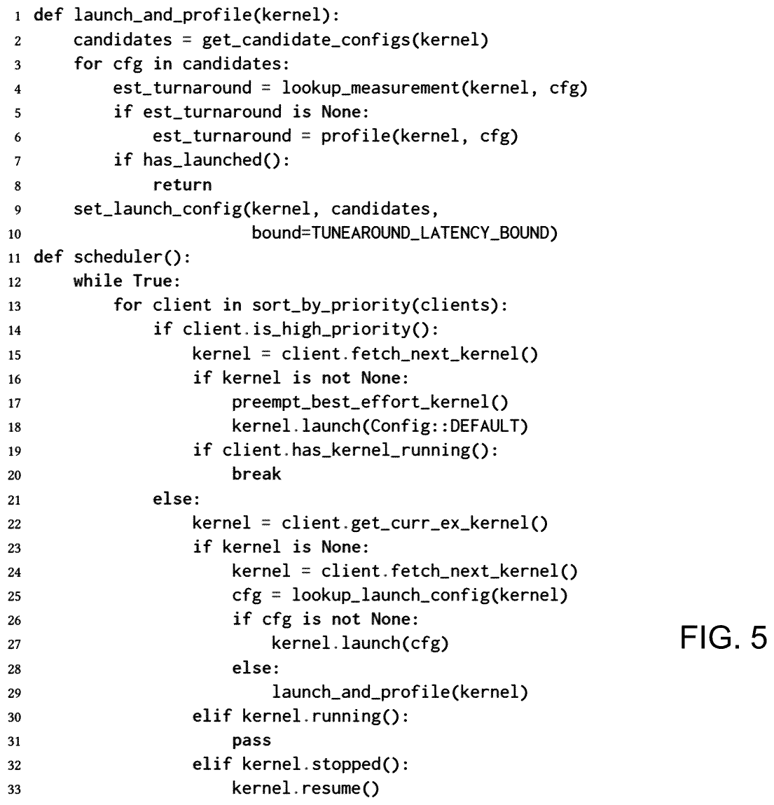

The following now demonstrates how Tally's priority-aware scheduler leverages the aforementioned slicing and preemption primitives and the transparent profiler to enforce priority among the scheduling of concurrent workloads. The algorithm of the scheduler, as outlined in FIG. 5, follows an opportunistic strategy: it prioritizes the immediate dispatch of high-priority kernels upon their arrival (lines 14 to 20) and schedules low-priority kernels to execute when the high priority job becomes inactive (lines 21 to 33). Due to the reactive nature of this algorithm, incoming high-priority kernels may need to wait for the completion of currently executing low-priority kernels, potentially introducing delays to the execution of high-priority tasks. To mitigate such queuing delays, each best-effort kernel is either launched as multiple sub-kernels one at a time, or in its preemptive version, such that they can be preempted in the event of a high-priority kernel arriving during its execution.

The primary challenge of this strategy lies in determining the appropriate launch configuration for each best-effort kernel, which includes deciding whether to employ slicing or preemption and setting the corresponding parameters for each method. First, due to the inherent difference in their implementation, each of the two primitives exhibits distinct performance trade-offs. While slicing is a lightweight transformation, it can incur overhead due to multiple kernel launches. Conversely, the preemption kernel requires only a single launch, but the additional synchronization and control flow can introduce noticeable overhead to certain kernels. As a result, their relative performance across different kernels varies considerably, posing challenges for the scheduler in choosing between the two. Moreover, for each primitive, the scheduler may need to determine the corresponding parameter, which includes the number of slices for slicing and the number of workers for preemption. These decisions can be important as they significantly affect the performance behavior of the concurrent workloads. For instance, in the context of preemptive scheduling, allocating fewer workers can expedite the preemption process but can potentially slow down the execution of best-effort tasks, thereby diminishing the overall benefits of GPU sharing.

To strike a balance between robust performance isolation for high-priority tasks and maintaining acceptable throughput for low-priority tasks, Tally's priority-aware scheduler employs a profile-guided resource provisioning policy. This policy leverages runtime measurements to determine the optimal launch configuration for each best-effort kernel through a search process. As depicted in FIG. 5, lines 2 to 10, for each kernel, the scheduler generates a list of candidate configurations encompassing both slicing and preemption. For preemption, this can be done by considering all multiples of the number of SMs that fit within the thread limit. Whereas slicing may set the degree of slicing based on having each slice operating different percentages of the total blocks. These configurations are then profiled by Tally's transparent profiler. To evaluate the performance of these candidate configurations, Tally uses the metric turnaround latency mentioned in Section 3, defined as the estimated time required for a best-effort kernel to release resources. Calculating the turnaround latency for a sliced kernel is relatively straightforward, by simply measuring the completion time of a kernel slice. In contrast, measuring the turnaround latency for preemptive kernels is more challenging due to its use of dynamic worker blocks. Therefore, we compute this figure using a heuristic method by dividing the total duration of the kernel by the number of blocks assigned to each worker, as:

$$turnaround\_latency = \frac{kernal\_latency}{total\_blocks / worker\_blocks} ,$$

which estimate the latency for waiting for each worker to complete the current block of execution. Finally, the scheduler selects the best performing configuration that meets a predefined turnaround latency threshold, which serves as a configurable parameter to balance the performance trade-offs between high and low-priority workloads. Empirically, we find that a default value of 0.0316 ms can effectively render robust performance isolation while producing competitive system throughput (details in Section 5.5).

### 4.3 Non-Intrusive Virtualization Layer

Finally, the following presents details on the implementation of Tally's virtualization layer. On the application-side, Tally utilizes the LD_PRELOAD mechanism in Linux to intercept device API calls, redirecting them to a surrogate function that mirrors the API's original signature. These intercepted API calls are sent to the server, which handles the actual device execution. The challenge in this process is enabling the server, which operates in a separate address space, to execute client kernel functions. The solution leverages a critical insight: GPU applications register device code with the GPU driver at the start of execution. By intercepting this process, the server gains access to the device code, including kernel binaries and device code, which we use at the server-side to apply kernel transformations and recompile to executable GPU kernels.

A notable concern with this interception and forwarding approach is the potential communication overhead, which could impact application performance. To mitigate this, the following implements two optimizations. First, the system can utilize efficient shared memory channels for client-server communication, which significantly reduces the overhead by avoiding context switches during message passing. Second, it may be observed that the need to forward many frequent device API calls, such as cudaGetDevice in NVIDIA, can be avoided by maintaining local states of the execution context on the client side. This approach effectively minimizes the frequency of API call forwarding between the client and server, further reducing the communication overhead. These strategies collectively enable Tally to operate transparently with near-native performance across all the concurrent DL tasks.

### 5. Evaluation

### 5.1 Methodology

### Workloads

For Tally evaluation, one may prepare a benchmark suite comprising six training and six inference workloads as listed in Table 2, covering a diverse range of widely used DL model architectures, such as CNNs (e.g., ResNet50 [25]), transformer-based LLMs (e.g., Llama-2 [52]), and diffusion models (e.g., Stable Diffusion [46]).

TABLE 2
Training and inference benchmarks

| Training | | # | | Through- | |
|---|---|---|---|---|---|
| Model | Dataset | Params | | put | |
| ResNet50 [25] | ImageNet [17] | 25.6 | M | 1.0 | it/s |
| PointNet [42] | ShapeNet [11] | 3.5 | M | 40.0 | it/s |
| BERT [19] | SQUAD [45] | 110 | M | 1.8 | it/s |
| GPT2-Large [44] | Wikitext2 [34] | 774 | M | 3.3 | it/s |
| PEGASUS [63] | XSum [35] | 568 | M | 2.9 | it/s |
| Whisper-v3 [43] | Libri- | 1.5 | B | 0.3 | it/s |
| | Speech [40] | | | | |
| Inference | | # | | | |
| Model | Engine | Params | | Latency | |
| ResNet50 [25] | Hidet [20] | 25.6 | M | 1.37 | ms |
| BERT [19] | ONNX | 110 | M | 3.93 | ms |
| | RT [18] | | | | |
| YOLOvem [32] | Torch- | 34.9 | M | 17.5 | ms |
| | Inductor [5] | | | | |
| Llama-2-7b [52] | ONNX | 7 | B | 1.9 | s |
| | RT [18] | | | | |
| Stable | Torch- | 983 | M | 2.5 | s |
| Diffusion [46] | Inductor [5] | | | | |
| GPT-Neo [9] | Torch- | 2.7 | B | 3.6 | s |
| | Inductor [5] | | | | |

Training workloads are implemented using PyTorch [41], a broadly adopted DL framework in the research community. For inference workloads, one may use high-performance engines such as ONNX Runtime [18], TorchInductor [5], and Hidet [20]. Inspired by prior DL serving benchmarks [8, 24, 33], one can simulate inference workloads using the Microsoft Azure Function Trace 2021 (MAF2) [65], a dataset of Azure serverless function invocations that has been repurposed for DL serving workloads. Extract the trace of the most frequently invoked function to adapt it to match specific traffic loads based on the query latency of the models. Define load as the percentage of time an inference service is actively serving requests.

### Metrics

One can use the 99th percentile latency as the primary metric for assessing the performance of inference tasks. For both training and inference tasks, measure their throughput, defined as the number of samples processed per unit of time. To evaluate the overall performance of concurrent task execution, utilize system throughput, calculated by aggregating the normalized throughput of individual workloads.

### Baselines

Compare the performance of Tally against four state-of-the-art non-intrusive GPU sharing solutions: (i) Time-Slicing, (ii) MPS, (iii) MPS-Priority and (iv) TGS. All these solutions perform scheduling at the kernel-level granularity. More specifically, Time-Slicing and MPS are the proprietary concurrency solutions provided by NVIDIA GPUs. MPS-Priority refers to MPS with the client priority control feature enabled, which allows specifying priority levels among concurrent workloads. Lastly, TGS is a GPU sharing system specifically designed for DL workloads, which leverages adaptive rate control mechanisms to achieve performance isolation among concurrent workloads.

### Experimental Setup

All experiments are conducted on an AWS EC2 p4d.24xlarge instance, a production-grade GPU server widely deployed in DL clusters. This machine has 96 core Intel Xeon Platinum 8275CL CPU, 1152 GB of DRAM, and 8 NVIDIA A100 GPUs, each with 40 GB of memory. The server operates on Ubuntu 20.04 with CUDA 12.2, PyTorch 2.2.0, ONNX Runtime GPU 1.17.0, and Hidet 0.3.0.

### 5.2 End-to-End Results

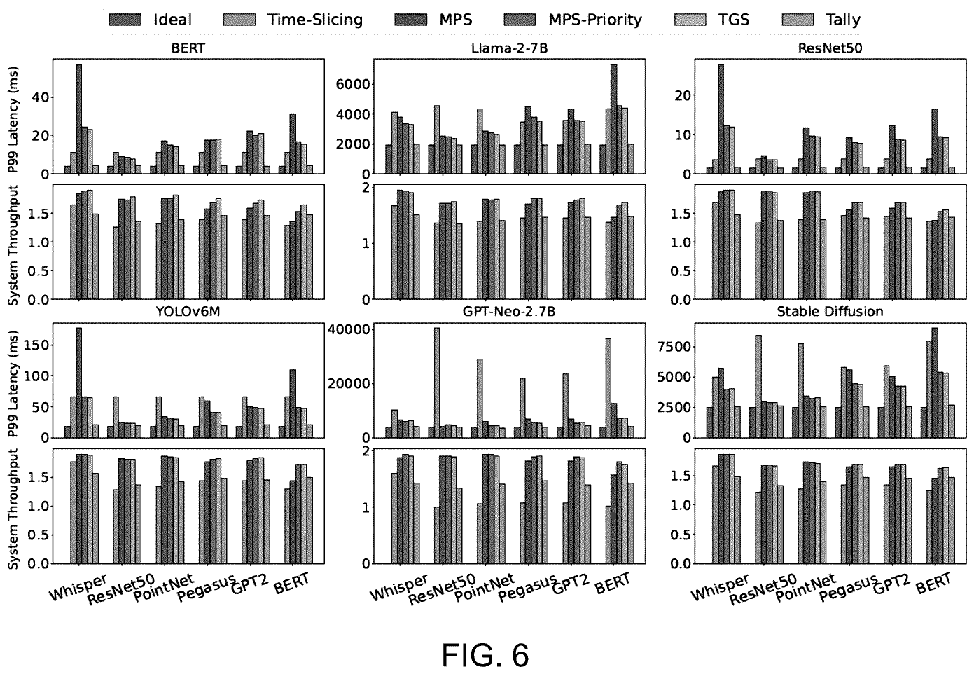

First analyze Tally's end-to-end performance in efficiently sharing GPU resources among multiple workloads while guaranteeing performance isolation for high-priority inference tasks. To this end, measure the 99th-percentile latencies of the inference tasks and the overall system throughput achieved by Tally when executed concurrently with a best-effort training workload. First, compare the latency metrics against the state-of-the-art non-intrusive GPU sharing systems, namely Time-Slicing, MPS, MPS-Priority, and TGS, as well as against the ideal scenario of running the inference task in isolation. FIG. 6 presents the latency and throughput measurements for all inference-training combinations from the benchmark suite, with inference tasks simulated using the MAF2 trace with a fixed 50% load. The results demonstrate Time-Slicing, MPS, MPS-Priority, and TGS exhibit significantly high overhead compared to the ideal latency, with an average of 252.3%, 345.0%, 195.5%, and 188.9%, respectively. The suboptimal inference latencies exhibited by Time-Slicing and MPS can be attributed to their priority-agnostic design, which focuses solely on maximizing system utilization. MPS-Priority and TGS, on the other hand, exhibit improved latency by prioritizing kernel execution of high-priority tasks over best-effort tasks. However, their coarse-grained kernel-level scheduling strategy fails to effectively mitigate co-execution interference. In stark contrast, Tally consistently maintains tail latencies nearly identical to the ideal latencies of the high-priority workloads, with an average percentage increase of mere 7.2%. This stronger performance isolation capability can be attributed to the block-level scheduling strategy that may be followed.

In addition to latency, compare the overall system throughput of Tally against the baseline GPU sharing systems. Tally demonstrates competitive performance relative to the baselines, attaining an average of 105.2%, 83.6%, 80.6%, and 80.3% of the system throughput achieved by the four baseline systems, respectively. This shows the ability of Tally's priority-aware scheduler to opportunistically schedule best-effort kernels while preserving latency requirements of high-priority tasks in shared execution environments.

Furthermore, it may be observed that MPS, MPS-Priority, and TGS exhibit substantial variation in performance degradation for high-priority inference tasks across different workload combinations. For instance, TGS experiences performance degradation ranging from 15.6% to 751.7%. This variation in latency reveals the sensitivity of these systems to workload characteristics, such as the differences in kernel duration across various tasks. As these systems schedules at the kernel-level, their performance deteriorates more severely for workloads with longer kernels. In contrast, Tally's block-level scheduling demonstrates robust performance against variations in kernel duration, effectively limiting the performance degradation of inference tasks to under 10% across 70% of the workload combinations (worst-case 23% on ResNet50).

### 5.3 Traffic Load Sensitivity Analysis

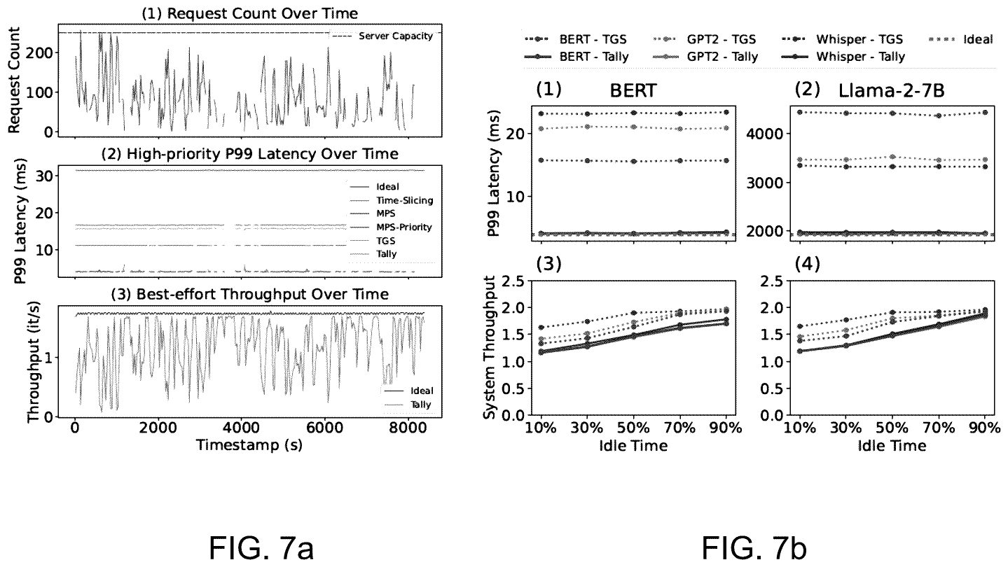

Next evaluate the sensitivity of Tally's performance isolation capabilities to varying traffic loads. For this experiment, use BERT and Llama-2-7B as the inference tasks representative of low-latency (3.93 ms) and long-latency (1.9 s) workloads. Each of them is paired with three distinct training workloads: BERT, GPT2, and Whisper, chosen for their observed tendency to cause significant interference. FIG. 7b (1) and (2) present a comparative analysis of the 99th-percentile latency for the inference tasks under Tally and TGS relative to the original latency as a function of GPU idle time (calculated as 100%-load) ranging from 10% to 90%. The results demonstrate that both inference tasks under Tally exhibit latencies indistinguishable from their original performance consistently across varying loads. In contrast, TGS incurs latency slowdowns of up to 5.8× and 2.3× for BERT and Llama-2-7B, respectively. These findings demonstrate the robustness of Tally's performance isolation capabilities for high-priority inference tasks, regardless of traffic load or the characteristics of the paired training workload.

Further analyze the relationship between Tally's achievable throughput and traffic load. FIG. 7b (3) and (4) illustrate the system throughput under Tally and TGS as a function of idle time. Both systems exhibit an upward trend in system throughput as the percentage of idle time increases, indicating their ability to leverage available resources for improved performance. During periods of high traffic load, there is a noticeable difference between the two systems. For instance, at 10% idle time, the system throughput under Tally is 1.19, whereas TGS achieves 1.65. This difference is attributed to Tally's strict priority enforcement policy, which executes best-effort tasks only when the high-priority task is inactive, sacrificing potential throughput gains for the preservation of the high-priority task's latency. In contrast, TGS achieves higher throughput but at the cost of significant slowdowns in tail latency, as demonstrated earlier. Nevertheless, as idle time increases, the throughput difference between Tally and TGS diminishes. This convergence indicates that for scenarios where heavy underutilization is observed, Tally not only offers reliable performance isolation guarantees but also achieves competitive throughput compared to other GPU sharing systems.

To further analyze the adaptive nature of Tally to varying traffic load, in FIG. 5a, the real-time traffic trace to a BERT inference task has been plotted (a condensed version of the original MAF2 trace), and measure the real-time tail latency and throughput when co-located with another BERT training task. FIG. 7a illustrates (1) the real-time traffic to a BERT inference task, (2) 99th percentile latency of the inference server achieved by different GPU sharing systems and (3) the throughput of the co-located best-effort BERT training achieved by Tally compared to the original throughput of the training task.

As shown in FIG. 7a (2), the tail latency under Tally, represented by the purple line, closely aligns with the ideal latency depicted by the blue line, with negligible deviation throughout the simulation period. Whereas alternative approaches such as Time-Slicing, MPS, MPS-Priority, and TGS result in substantial slowdowns in latency as depicted. Additionally, FIG. 7a (3) shows Tally's ability to opportunistically adjust the throughput of the best-effort task in correspondence with the fluctuating traffic load to the high-priority inference task, as discussed in Section 4. As a result, Tally preserves over 68% of the training task's original throughput simultaneously running the high-priority inference workload on the same GPU without affecting its latency requirements.

5.4 Scalability with Number of Workloads

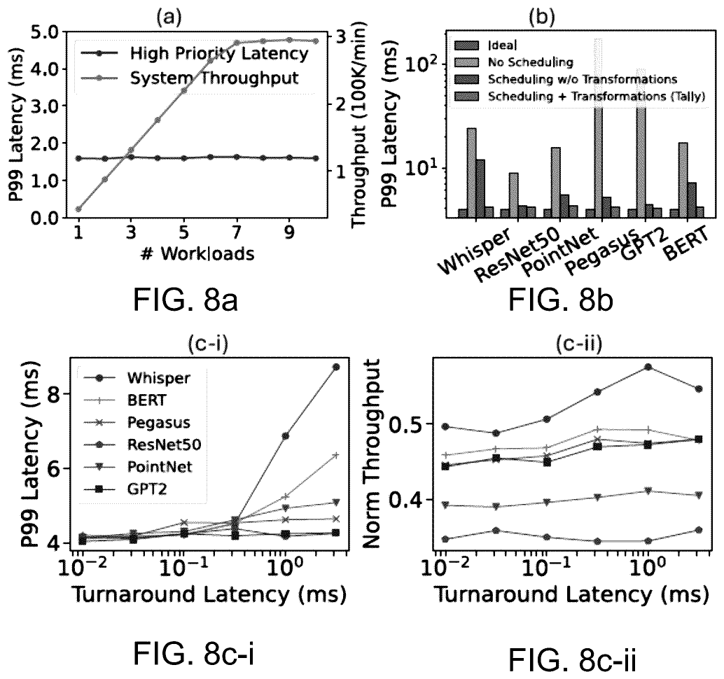

To demonstrate Tally's ability to support multiple best-effort workloads while preserving the performance of the co-located high-priority job, extend the experiments beyond the two-job scenario. One can design an experiment with a set of identical ResNet50 inference workloads, each operating at a low traffic load of 10% and one of these workloads designated as the high-priority online inference task while the rest as best-effort offline inference tasks. Measure 99th-percentile latency of the high-priority task and the aggregated system throughput, measured in number of requests processed per minute, as one scales up the number of best effort tasks. The results in FIG. 8(a), reveal that the latency of the high-priority task remains consistent throughout the spectrum of scaling from 1 to 10 workloads. At the same time, the system throughput exhibits a steady increase as the number of workloads grows, until the GPU saturates at 8 concurrent best-effort workloads. This shows that Tally can be particularly useful in scenarios where numerous jobs exhibit extremely low utilization, as Tally can efficiently pack these workloads together to maximize system throughput without compromising the performance of high-priority tasks.

### 5.5 Ablation Study

### Performance Decomposition

Analyze the importance of Tally's priority-aware scheduling algorithm and block level transformation for performance isolation. FIG. 8(b) compares the 99th-percentile latency of a high-priority BERT model when co-located with training workloads from the benchmark suite. Ideal denotes the original latency of the task executed in isolation. No-scheduling refers to the indiscriminate dispatching of kernels from both workloads upon arrival. Scheduling w/o transformation employs Tally's priority-aware scheduling without kernel transformations, while Scheduling with transformation represents the full implementation of Tally, utilizing slicing and preemption mechanisms for block-level scheduling. The results reveal that No-scheduling incurs substantial latency overhead across all six job combinations, with the most severe case exhibiting a 30× slowdown when co-located with Whisper. This significant performance degradation is attributable to the absence of priority enforcement, resulting in considerable co-execution interference. The integration of Tally's priority aware kernel-level scheduling strategy somewhat mitigates this overhead. For ResNet50 and GPT2, this approach yields latencies close to ideal performance, with 8.0% and 9.8% slowdown respectively. However, for workloads such as Whisper and BERT, the latency slowdown can still reach up to 10×. This difference in slowdown is attributed to the variation in kernel duration distribution. For instance, 99.3% of kernels in ResNet50 complete in less than 0.1 ms, whereas 5.6% of kernels in Whisper exceed the duration of an entire BERT inference (3.93 ms). These prolonged kernels significantly delay the execution of high-priority kernels. Notably, with kernel transformation enabled, i.e., with full Tally, the latency overhead becomes negligible across all six training workloads, resulting in an average of 4.0% slowdown (6.2% in the worst case). This shows the necessity of block-level scheduling in maintaining robust performance isolation guarantees.

### Turnaround Latency Analysis

Examine the impact of the turnaround latency threshold (delineated in Section 4) by evaluating the tail latency of the BERT inference workload and the normalized throughput of the co-located training job on six models and across six distinct threshold values, ranging from 0.01 ms to 10 ms. The results, depicted in FIG. 8c-i and 8c-ii, show that higher turnaround latency thresholds generally correspond to increased tail latency for the inference workload with only slight increase in the throughput. Based on these empirical results, one can find that a turnaround latency threshold of 0.0316 ms provides the best balance between latency and throughput, which is the default setting used throughout the experiments.

### 6. Related Work

Many GPU sharing systems are designed with the goal of maximizing the throughput. Time-Slicing [22] and MPS [1] provided in NVIDIA GPUs enable transparent sharing of GPU resources in temporal and spatial manners. Besides vendor-provided options, many works [16, 51, 55] have been built on the concept of co-executing kernels with complementary resource demands (e.g., compute vs. memory intensive) to further exploit resource parallelism in GPU SMs. For instance, Kernelet [68] and Slate [4] perform such scheduling at runtime, while Kernel Fusion [53], HFUSE [31], Tacker [67], and ISPA [66] employ source-to-source transformation to fuse kernels during compilation. Systems in this category fundamentally cannot support performance isolation as they prioritize the overall efficiency of the system over preservation of performance of certain high-priority workloads, thus falling short in production scenarios where tasks have SLAs.

Meanwhile, systems that are designed with performance isolation support, like Effisha [13] and GPES [69], utilize block-level preemption techniques to mitigate interference in concurrent execution but they require access to application source code. In contrast, Tally operates non-intrusively. AntMan [59] and TGS [57] leverage the iterative nature of DL training to adaptively limit the resources of low-priority tasks based on performance feedback from high-priority jobs. REEF [24] implements a reset-based scheduling mechanism that achieves microsecond-scale kernel preemption latency on idempotent kernels. However, these works rely on specific task characteristics and cannot generalize to the wide variety of DL workloads. Conversely, Tally supports broad compatibility using task-agnostic scheduling and kernel transformations. Furthermore, Orion [48] enhances performance isolation with kernel-level scheduling with consideration on each kernel's compute and memory requirements. However, Orion requires offline profiling of workloads, which can be challenging to accomplish in cluster settings. Whereas Tally employs transparent profiling for priority-aware scheduling.

### 7. Conclusion

This disclosure highlights the limitations of current GPU sharing systems and their inability to meet the versatile requirements of modern large-scale DL clusters. To address these limitations, Tally provides a non-intrusive GPU sharing mechanism that offers robust performance isolation and universal applicability to diverse DL workloads. The above empirically shows that Tally can effectively ensure the performance standards of latency-critical tasks during shared execution, incurring a mere 7.2% overhead on average on a diverse set of workload combinations, compared to 188.9% minimal overhead in state-of-the-art non-intrusive GPU sharing systems while offering competitive system throughput.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### References

[1] Multi-process service. Available online, 2024. https://docs.nvidia.com/deploy/mps/.

[2] Martin Abadi, Paul Barham, Jianmin Chen, Zhifeng Chen, Andy Davis, Jeffrey Dean, Matthieu Devin, Sanjay Ghemawat, Geoffrey Irving, Michael Isard, Manjunath Kudlur, Josh Levenberg, Rajat Monga, Sherry Moore, Derek G. Murray, Benoit Steiner, Paul Tucker, Vijay Vasudevan, Pete Warden, Martin Wicke, Yuan Yu, and Xiaoqiang Zheng. Tensorflow: A system for large-scale machine learning. In 12th USENIX Symposium on Operating Systems Design and Implementation (OSDI 16), pages 265-283, 2016.

[3] Taleb Alashkar, Songyao Jiang, ShuyangWang, and Yun Fu. Examples rules guided deep neural network for makeup recommendation. In Proceedings of the AAAI conference on artificial intelligence, volume 31, 2017.

[4] Tyler Allen, Xizhou Feng, and Rong Ge. Slate: Enabling workload aware efficient multiprocessing for modern gpgpus. In 2019 IEEE International Parallel and Distributed Processing Symposium (IPDPS), pages 252-261, 2019.

[5] Jason Ansel, Edward Yang, Horace He, Natalia Gimelshein, Animesh Jain, Michael Voznesensky, Bin Bao, Peter Bell, David Berard, Evgeni Burovski, Geeta Chauhan, Anjali Chourdia, Will Constable, Alban Desmaison, Zachary DeVito, Elias Ellison, Will Feng, Jiong Gong, Michael Gschwind, Brian Hirsh, Sherlock Huang, Kshiteej Kalambarkar, Laurent Kirsch, Michael Lazos, Mario Lezcano, Yanbo Liang, Jason Liang, Yinghai Lu, C. K. Luk, Bert Maher, Yunjie Pan, Christian Puhrsch, Matthias Reso, Mark Saroufim, Marcos Yukio Siraichi, Helen Suk, Shunting Zhang, Michael Suo, Phil Tillet, Xu Zhao, Eikan Wang, Keren Zhou, Richard Zou, Xiaodong Wang, Ajit Mathews, William Wen, Gregory Chanan, Peng Wu, and Soumith Chintala. Pytorch 2: Faster machine learning through dynamic python bytecode transformation and graph compilation. In Proceedings of the 29th ACM International Conference on Architectural Support for Programming Languages and Operating Systems, Volume 2, ASPLOS '24, page 929-947, New York, NY, USA, 2024. Association for Computing Machinery.

[6] Andrew Audibert, Yang Chen, Dan Graur, Ana Klimovic, Jiří Šimša, and Chandramohan A. Thekkath. tf.data service: A case for disaggregating ml input data processing. In Proceedings of the 2023 ACM Symposium on Cloud Computing, SoCC '23, page 358-375, New York, NY, USA, 2023. Association for Computing Machinery.

[7] Dzmitry Bahdanau, Kyunghyun Cho, and Yoshua Bengio. Neural machine translation by jointly learning to align and translate. In Yoshua Bengio and Yann LeCun, editors, 3rd International Conference on Learning Representations, ICLR 2015, San Diego, CA, USA, May 7-9, 2015, Conference Track Proceedings, 2015.

[8] Anirban Bhattacharjee, Ajay Dev Chhokra, Zhuangwei Kang, Hongyang Sun, Aniruddha Gokhale, and Gabor Karsai. Barista: Efficient and scalable serverless serving system for deep learning prediction services. In 2019 IEEE International Conference on Cloud Engineering (IC2E), pages 23-33. IEEE, 2019.

[9] Sid Black, Gao Leo, Phil Wang, Connor Leahy, and Stella Biderman. GPT-Neo: Large Scale Autoregressive Language Modeling with Mesh-Tensorflow, March 2021. If you use this software, please cite it using these metadata.

[10] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, et al. Language models are few-shot learners. Advances in neural information processing systems, 33:1877-1901, 2020.

[11] Angel X Chang, Thomas Funkhouser, Leonidas Guibas, Pat Hanrahan, Qixing Huang, Zimo Li, Silvio Savarese, Manolis Savva, Shuran Song, Hao Su, et al. Shapenet: An information-rich 3d model repository. arXiv preprint arXiv:1512.03012, 2015.

[12] Chao Chen, Chris Porter, and Santosh Pande. Case: a compiler-assisted scheduling framework for multi-gpu systems. In Proceedings of the 27th ACM SIGPLAN Symposium on Principles and Practice of Parallel Programming, PPoPP '22, page 17-31, New York, NY, USA, 2022. Association for Computing Machinery.

[13] Guoyang Chen, Yue Zhao, Xipeng Shen, and Huiyang Zhou. Effisha: A software framework for enabling efficient preemptive scheduling of gpu. SIGPLAN Not., 52(8):3-16, January 2017.

[14] M. Cordts, M. Omran, S. Ramos, T. Rehfeld, M. Enzweiler, R. Benenson, U. Franke, S. Roth, and B. Schiele. The cityscapes dataset for semantic urban scene understanding. In 2016 IEEE Conference on Computer Vision and Pattern Recognition (CVPR), pages 3213-3223, Los Alamitos, CA, USA, June 2016. IEEE Computer Society.

[15] Daniel Crankshaw, Xin Wang, Guilio Zhou, Michael J. Franklin, Joseph E. Gonzalez, and Ion Stoica. Clipper: A Low-Latency online prediction serving system. In 14th USENIX Symposium on Networked Systems Design and Implementation (NSDI 17), pages 613-627, Boston, MA, March 2017. USENIX Association.

[16] Weihao Cui, Mengze Wei, Quan Chen, Xiaoxin Tang, Jingwen Leng, Li Li, and Mingyi Guo. Ebird: Elastic batch for improving responsiveness and throughput of deep learning services. In 2019 IEEE 37^{th} International Conference on Computer Design (ICCD), pages 497-505, 2019.

[17] Jia Deng, Wei Dong, Richard Socher, Li-Jia Li, Kai Li, and Li Fei-Fei. Imagenet: A large-scale hierarchical image database. In 2009 IEEE Conference on Computer Vision and Pattern Recognition, pages 248-255, 2009.

[18] ONNX Runtime developers. Onnx runtime. https://onnxruntime.ai/, 2021. Version: x.y.z.

[19] Jacob Devlin, Ming-Wei Chang, Kenton Lee, and Kristina Toutanova. BERT: Pre-training of deep bidirectional transformers for language understanding. In Jill Burstein, Christy Doran, and Thamar Solorio, editors, Proceedings of the 2019 Conference of the North American Chapter of the Association for Computational Linguistics: Human Language Technologies, Volume 1 (Long and Short Papers), pages 4171-4186, Minneapolis, Minnesota, June 2019. Association for Computational Linguistics.

[20] Yaoyao Ding, Cody Hao Yu, Bojian Zheng, Yizhi Liu, Yida Wang, and Gennady Pekhimenko. Hidet: Task-mapping programming paradigm for deep learning tensor programs. In Proceedings of the 28th ACM International Conference on Architectural Support for Programming Languages and Operating Systems, Volume 2, ASPLOS 2023, page 370-384, New York, NY, USA, 2023. Association for Computing Machinery.

[21] Doug Eadline. Nvidia h100: Are 550,000 gpus enough for this year?, August 2023.

[22] Guin Gilman and Robert J. Walls. Characterizing concurrency mechanisms for nvidia gpus under deep learning workloads. Performance Evaluation, 151:102234, 2021.

[23] Inc. Google. Kubernetes: Production-grade container orchestration. https://kubernetes.io, 2014. Accessed: 2024 Jun. 24.

[24] Mingcong Han, Hanze Zhang, Rong Chen, and Haibo Chen. Microsecond-scale preemption for concurrent GPU-accelerated DNN inferences. In 16th USENIX Symposium on Operating Systems Design and Implementation (OSDI 22), pages 539-558, Carlsbad, CA, July 2022. USENIX Association.

[25] Kaiming He, Xiangyu Zhang, Shaoqing Ren, and Jian Sun. Deep residual learning for image recognition. In 2016 IEEE Conference on Computer Vision and Pattern Recognition (CVPR), pages 770-778, 2016.

[26] Qinghao Hu, Peng Sun, Shengen Yan, Yonggang Wen, and Tianwei Zhang. Characterization and prediction of deep learning workloads in large-scale gpu datacenters. In Proceedings of the International Conference for High Performance Computing, Networking, Storage and Analysis, pages 1-15, 2021.

[27] Qinghao Hu, Meng Zhang, Peng Sun, Yonggang Wen, and Tianwei Zhang. Lucid: A non-intrusive, scalable and interpretable scheduler for deep learning training jobs. In Proceedings of the 28th ACM International Conference on Architectural Support for Programming Languages and Operating Systems, Volume 2, ASPLOS 2023, page 457-472, New York, NY, USA, 2023. Association for Computing Machinery.

[28] Alex Krizhevsky, Ilya Sutskever, and Geoffrey E Hinton. Imagenet classification with deep convolutional neural networks. In F. Pereira, C. J. Burges, L. Bottou, and K. Q. Weinberger, editors, Advances in Neural Information Processing Systems, volume 25. Curran Associates, Inc., 2012.

[29] Kevin Lee, Kevin Lee, Adi Gangidi, and Mathew Oldham. Building meta's genai infrastructure, May 2024.

[30] Mike Lewis, Yinhan Liu, Naman Goyal, Marjan Ghazvininejad, Abdelrahman Mohamed, Omer Levy, Veselin Stoyanov, and Luke Zettlemoyer. BART: Denoising sequence-to-sequence pre-training for natural language generation, translation, and comprehension. In Dan Jurafsky, Joyce Chai, Natalie Schluter, and Joel Tetreault, editors, Proceedings of the 58th Annual Meeting of the Association for Computational Linguistics, pages 7871-7880, Online, July 2020. Association for Computational Linguistics.

[31] Ao Li, Bojian Zheng, Gennady Pekhimenko, and Fan Long. Automatic horizontal fusion for gpu kernels. In 2022 IEEE/ACM International Symposium on Code Generation and Optimization (CGO), pages 14-27. IEEE, 2022.

[32] Chuyi Li, Lulu Li, Hongliang Jiang, Kaiheng Weng, Yifei Geng, Liang Li, Zaidan Ke, Qingyuan Li, Meng Cheng, Weiqiang Nie, et al. Yolov6: A single-stage object detection framework for industrial applications. arXiv preprint arXiv:2209.02976, 2022.

[33] Zhuohan Li, Lianmin Zheng, Yinmin Zhong, Vincent Liu, Ying Sheng, Xin Jin, Yanping Huang, Zhifeng Chen, Hao Zhang, Joseph E. Gonzalez, and Ion Stoica. AlpaServe: Statistical multiplexing with model parallelism for deep learning serving. In 17th USENIX Symposium on Operating Systems Design and Implementation (OSDI 23), pages 663-679, Boston, MA, July 2023. USENIX Association.

[34] Stephen Merity, Caiming Xiong, James Bradbury, and Richard Socher. Pointer sentinel mixture models, 2016.

[35] Shashi Narayan, Shay B. Cohen, and Mirella Lapata. Don't give me the details, just the summary! Topic-aware convolutional neural networks for extreme summarization. In Proceedings of the 2018 Conference on Empirical Methods in Natural Language Processing, Brussels, Belgium, 2018.

[36] Deepak Narayanan, Keshav Santhanam, Fiodar Kazhamiaka, Amar Phanishayee, and Matei Zaharia. {Heterogeneity-Aware} cluster scheduling policies for deep learning workloads. In 14th USENIX Symposium on Operating Systems Design and Implementation (OSDI 20), pages 481-498, 2020.

[37] Deepak Narayanan, Keshav Santhanam, Fiodar Kazhamiaka, Amar Phanishayee, and Matei Zaharia. Heterogeneity-Aware cluster scheduling policies for deep learning workloads. In 14th USENIX Symposium on Operating Systems Design and Implementation (OSDI 20), pages 481-498. USENIX Association, November 2020.

[38] NVIDIA Corporation. CUDA C++ Programming Guide, version 12.5 edition, June 2024. https://docs.nvidia.com/cuda/cuda-c-programmingguide/.

[39] OpenAI. Chatgpt. Available online, 2024. https://chat.openai.com/chat.

[40] Vassil Panayotov, Guoguo Chen, Daniel Povey, and Sanjeev Khudanpur. Librispeech: An asr corpus based on public domain audio books. In 2015 IEEE International Conference on Acoustics, Speech and Signal Processing (ICASSP), pages 5206-5210, 2015.

[41] Adam Paszke, Sam Gross, Francisco Massa, Adam Lerer, James Bradbury, Gregory Chanan, Trevor Killeen, Zeming Lin, Natalia Gimelshein, Luca Antiga, et al. Pytorch: An imperative style, high performance deep learning library. Advances in neural information processing systems, 32, 2019.

[42] Charles R. Qi, Hao Su, Kaichun Mo, and Leonidas J. Guibas. Pointnet: Deep learning on point sets for 3d classification and segmentation. In Proceedings of the IEEE Conference on Computer Vision and Pattern Recognition (CVPR), July 2017.

[43] Alec Radford, Jong Wook Kim, Tao Xu, Greg Brockman, Christine McLeavey, and Ilya Sutskever. Robust speech recognition via largescale weak supervision. In International Conference on Machine Learning, pages 28492-28518. PMLR, 2023.

[44] Alec Radford, Jeffrey Wu, Rewon Child, David Luan, Dario Amodei, Ilya Sutskever, et al. Language models are unsupervised multitask learners. OpenAI blog, 1(8):9, 2019.

[45] Pranav Rajpurkar, Jian Zhang, Konstantin Lopyrev, and Percy Liang. SQuAD: 100,000+ questions for machine comprehension of text. In Jian Su, Kevin Duh, and Xavier Carreras, editors, Proceedings of the 2016 Conference on Empirical Methods in Natural Language Processing, pages 2383-2392, Austin, Texas, November 2016. Association for Computational Linguistics.

[46] Robin Rombach, Andreas Blattmann, Dominik Lorenz, Patrick Esser, and Björn Ommer. High-resolution image synthesis with latent diffusion models. In Proceedings of the IEEE/CVF conference on computer vision and pattern recognition, pages 10684-10695, 2022.

[47] Dharma Shukla, Muthian Sivathanu, Srinidhi Viswanatha, Bhargav Gulavani, Rimma Nehme, Amey Agrawal, Chen Chen, Nipun Kwatra, Ramachandran Ramjee, Pankaj Sharma, et al. Singularity: Planet-scale, preemptive and elastic scheduling of ai workloads. arXiv preprint arXiv:2202.07848, 2022.

[48] Foteini Strati, Xianzhe Ma, and Ana Klimovic. Orion: Interference aware, fine-grained gpu sharing for ml applications. In Proceedings of the Nineteenth European Conference on Computer Systems, EuroSys '24, page 1075-1092, New York, NY, USA, 2024. Association for Computing Machinery.

[49] Ilya Sutskever, Oriol Vinyals, and Quoc V. Le. Sequence to sequence learning with neural networks. In Proceedings of the 27th International Conference on Neural Information Processing Systems—Volume 2, NIPS'14, page 3104-3112, Cambridge, MA, USA, 2014. MIT Press.

[50] Christian Szegedy, Wei Liu, Yangqing Jia, Pierre Sermanet, Scott Reed, Dragomir Anguelov, Dumitru Erhan, Vincent Vanhoucke, and Andrew Rabinovich. Going deeper with convolutions. In 2015 IEEE Conference on Computer Vision and Pattern Recognition (CVPR), pages 1-9, 2015.

[51] Xiaodan Serina Tan, Pavel Golikov, Nandita Vijaykumar, and Gennady Pekhimenko. Gpupool: A holistic approach to fine-grained gpu sharing in the cloud. In Proceedings of the International Conference on Parallel Architectures and Compilation Techniques, PACT '22, page 317-332, New York, NY, USA, 2023. Association for Computing Machinery.

[52] Hugo Touvron, Louis Martin, Kevin Stone, Peter Albert, Amjad Almahairi, Yasmine Babaei, Nikolay Bashlykov, Soumya Batra, Prajjwal Bhargava, Shruti Bhosale, Dan Bikel, Lukas Blecher, Cristian Canton Ferrer, Moya Chen, Guillem Cucurull, David Esiobu, Jude Fernandes, Jeremy Fu, Wenyin Fu, Brian Fuller, Cynthia Gao, Vedanuj Goswami, Naman Goyal, Anthony Hartshorn, Saghar Hosseini, Rui Hou, Hakan Inan, Marcin Kardas, Viktor Kerkez, Madian Khabsa, Isabel Kloumann, Artem Korenev, Punit Singh Koura, Marie-Anne Lachaux, Thibaut Lavril, Jenya Lee, Diana Liskovich, Yinghai Lu, Yuning Mao, Xavier Martinet, Todor Mihaylov, Pushkar Mishra, Igor Molybog, Yixin Nie, Andrew Poulton, Jeremy Reizenstein, Rashi Rungta, Kalyan Saladi, Alan Schelten, Ruan Silva, Eric Michael Smith, Ranjan Subramanian, Xiaoqing Ellen Tan, Binh Tang, Ross Taylor, Adina Williams, Jian Xiang Kuan, Puxin Xu, Zheng Yan, Iliyan Zarov, Yuchen Zhang, Angela Fan, Melanie Kambadur, Sharan Narang, Aurelien Rodriguez, Robert Stojnic, Sergey Edunov, and Thomas Scialom. Llama 2: Open foundation and fine-tuned chat models, 2023.

[53] Guibin Wang, YiSong Lin, and Wei Yi. Kernel fusion: An effective method for better power efficiency on multithreaded gpu. pages 344-350, 2010.

[54] Shang Wang, Peiming Yang, Yuxuan Zheng, Xin Li, and Gennady Pekhimenko. Horizontally fused training array: An effective hardware utilization squeezer for training novel deep learning models. Proceedings of Machine Learning and Systems, 3:599-623, 2021.

[55] Zhenning Wang, Jun Yang, Rami Melhem, Bruce Childers, Youtao Zhang, and Minyi Guo. Simultaneous multikernel gpu: Multi-tasking throughput processors via fine-grained sharing. In 2016 IEEE International Symposium on High Performance Computer Architecture (HPCA), pages 358-369, 2016.

[56] Qizhen Weng, Wencong Xiao, Yinghao Yu, Wei Wang, Cheng Wang, Jian He, Yong Li, Liping Zhang, Wei Lin, and Yu Ding. MLaaS in the wild: Workload analysis and scheduling in Large-Scale heterogeneous GPU clusters. In 19th USENIX Symposium on Networked Systems Design and Implementation (NSDI 22), pages 945-960, Renton, WA, April 2022. USENIX Association.

[57] BingyangWu, Zili Zhang, Zhihao Bai, Xuanzhe Liu, and Xin Jin. Transparent GPU sharing in container clouds for deep learning workloads. In 20th USENIX Symposium on Networked Systems Design and Implementation (NSDI 23), pages 69-85, Boston, MA, April 2023. USENIX Association.

[58] Wencong Xiao, Romil Bhardwaj, Ramachandran Ramjee, Muthian Sivathanu, Nipun Kwatra, Zhenhua Han, Pratyush Patel, Xuan Peng, Hanyu Zhao, Quanlu Zhang, Fan Yang, and Lidong Zhou. Gandiva: Introspective cluster scheduling for deep learning. In 13th USENIX Symposium on Operating Systems Design and Implementation (OSDI 18), pages 595-610, Carlsbad, CA, October 2018. USENIX Association.

[59] Wencong Xiao, Shiru Ren, Yong Li, Yang Zhang, Pengyang Hou, Zhi Li, Yihui Feng, Wei Lin, and Yangqing Jia. AntMan: Dynamic scaling on GPU clusters for deep learning. In 14th USENIX Symposium on Operating Systems Design and Implementation (OSDI 20), pages 533-548. USENIX Association, November 2020.

[60] Peifeng Yu and Mosharaf Chowdhury. Fine-grained gpu sharing primitives for deep learning applications. In I. Dhillon, D. Papailiopoulos, and V. Sze, editors, Proceedings of Machine Learning and Systems, volume 2, pages 98-111, 2020.

[61] Ekim Yurtsever, Jacob Lambert, Alexander Carballo, and Kazuya Takeda. A survey of autonomous driving: Common practices and emerging technologies. IEEE access, 8:58443-58469, 2020.

[62] Chengliang Zhang, Minchen Yu, Wei Wang, and Feng Yan. MArk: Exploiting cloud services for Cost-Effective, SLO-Aware machine learning inference serving. In 2019 USENIX Annual Technical Conference (USENIX ATC 19), pages 1049-1062, Renton, WA, July 2019. USENIX Association.

[63] Jingqing Zhang, Yao Zhao, Mohammad Saleh, and Peter Liu. Pegasus: Pre-training with extracted gap-sentences for abstractive summarization. In International conference on machine learning, pages 11328-11339. PMLR, 2020.

[64] Shuai Zhang, Lina Yao, Aixin Sun, and Yi Tay. Deep learning based recommender system: A survey and new perspectives. ACM Comput.Surv., 52(1), February 2019.

[65] Yanqi Zhang, Íñigo Goiri, Gohar Irfan Chaudhry, Rodrigo Fonseca, Sameh Elnikety, Christina Delimitrou, and Ricardo Bianchini. Faster and cheaper serverless computing on harvested resources. In Proceedings of the ACM SIGOPS 28th Symposium on Operating Systems Principles, SOSP '21, page 724-739, New York, NY, USA, 2021. Association for Computing Machinery.

[66] Han Zhao, Weihao Cui, Quan Chen, and Minyi Guo. Ispa: Exploiting intra-sm parallelism in gpus via fine-grained resource management. IEEE Trans. Comput., 72(5):1473-1487, May 2023.

[67] Han Zhao, Weihao Cui, Quan Chen, Youtao Zhang, Yanchao Lu, Chao Li, Jingwen Leng, and Minyi Guo. Tacker: Tensor-cuda core kernel fusion for improving the gpu utilization while ensuring qos. In 2022 IEEE International Symposium on High-Performance Computer Architecture (HPCA), pages 800-813, 2022.

[68] Jianlong Zhong and Bingsheng He. Kernelet: High-throughput gpu kernel executions with dynamic slicing and scheduling. IEEE Transactions on Parallel and Distributed Systems, 25(6):1522-1532, 2013.

[69] Husheng Zhou, Guangmo Tong, and Cong Liu. Gpes: a preemptive execution system for gpgpu computing. In 21st IEEE Real-Time and Embedded Technology and Applications Symposium, pages 87-97, 2015.

1. A method of facilitating graphics processing unit (GPU) sharing, comprising:
providing a transparent virtualization layer positioned between one or more applications and one or more GPUs to be used by the one or more applications;
intercepting device application programming interface (API) calls at the virtualization layer; and
executing a task-agnostic scheduling algorithm to prioritize execution of tasks associated with the API calls, by the one or more GPUs, by prioritizing high-priority tasks while opportunistically scheduling kernels on the one or more GPUs from best effort tasks during GPU idle cycles.

2. The method of claim 1, further comprising applying at least one task-agnostic kernel transformation.

3. The method of claim 1, wherein an application-side client library intercepts device code and the API calls initiated by a client processes and forwards the device code and API calls to a server providing the transparent virtualization layer.

4. The method of claim 3, wherein the server is responsible for managing device execution and scheduling.

5. The method of claim 1, wherein the virtualization layer provides performance isolation for the high-priority tasks by scheduling kernels from the best effort tasks at a block-level granularity using at least one of a slicing scheduling primitive and a preemption scheduling primitive.

6. The method of claim 5, wherein the slicing scheduling primitive divides a large kernel into a plurality of smaller segments, enabling more controlled scheduling.

7. The method of claim 5, wherein the preemption scheduling primitive allows for an interruption of active kernels.

8. The method of claim 5, wherein the slicing and preemption scheduling primitives are applied on GPU kernels through a series of transformation passes on kernel device code obtained through an interception of device API calls.

9. The method of claim 1, wherein the scheduling algorithm comprises a priority-aware scheduler that employs a profile-guided resource provisioning policy.

10. The method of claim 9, wherein the provisioning policy leverage runtime measurements to determine an optimal launch configuration for each best effort kernel through a search process.

11. The method of claim 1, wherein the scheduling algorithm aims to facilitate priority-enforced concurrent execution of one high priority task alongside multiple best effort tasks.

12. The method of claim 11, wherein the scheduling algorithm performs at least one of:
a kernel transformer, which leverages intercepted device code to convert kernels into slicing and preemptive-style kernels;
a transparent profiler, which profiles the performance of the transformed kernels under various launch configurations at runtime and predicts their estimated turnaround latencies; and
a priority-aware scheduler, which integrates the kernel transformer and transparent profiler and strategically schedules GPU execution of concurrent processes in a priority-aware manner.

13. A computer readable medium comprising computer-executable instructions that, when executed by at least one process of a computing system, cause the computing system to perform operations comprising:
providing a transparent virtualization layer positioned between one or more applications and one or more GPUs to be used by the one or more applications;
intercepting device application programming interface (API) calls at the virtualization layer; and
executing a task-agnostic scheduling algorithm to prioritize execution of tasks associated with the API calls, by the one or more GPUs, by prioritizing high-priority tasks while opportunistically scheduling kernels on the one or more GPUs from best effort tasks during GPU idle cycles.

14. The system of claim 13, further comprising applying at least one task-agnostic kernel transformation.

15. The system of claim 13, wherein an application-side client library intercepts device code and the API calls initiated by a client processes and forwards the device code and API calls to a server providing the transparent virtualization layer.

16. The system of claim 13, wherein the server is responsible for managing device execution and scheduling.

17. The system of claim 13, wherein the virtualization layer provides performance isolation for the high-priority tasks by scheduling kernels from the best effort tasks at a block-level granularity using at least one of a slicing scheduling primitive and a preemption scheduling primitive.

18. The method of claim 17, wherein the slicing scheduling primitive divides a large kernel into a plurality of smaller segments, enabling more controlled scheduling.

19. The method of claim 17, wherein the slicing and preemption scheduling primitives are applied on GPU kernels through a series of transformation passes on kernel device code obtained through an interception of device API calls.

20. A computing system comprising at least one processor and memory, the memory comprising computer executable instructions that, when executed by the at least one processor, cause the computing system to facilitate graphics processing unit (GPU) sharing by performing operations comprising:
providing a transparent virtualization layer positioned between one or more applications and one or more GPUs to be used by the one or more applications;
intercepting device application programming interface (API) calls at the virtualization layer; and
executing a task-agnostic scheduling algorithm to prioritize execution of tasks associated with the API calls, by the one or more GPUs, by prioritizing high-priority tasks while opportunistically scheduling kernels on the one or more GPUs from best effort tasks during GPU idle cycles.
